(19) United States
(12) Patent Application Publication
(10) Pub. No.: US 2002/0121383 A1
(43) Pub. Date: Sep. 5, 2002

(54) Back drag snow box

(76) Inventor: Gregory John Jasicki, Brooklyn Park, MN (US)

Correspondence Address: Gregory John Jasicki, 8056 Idaho Circle, Brooklyn Park, MN, 55445, US

(21) Appl. No.: 10/025,566

(22) Filed: Dec. 26, 2001

Related U.S. Application Data
(60) Provisional application No. 60/227,268, filed on Aug. 24, 2000.

(51) Int. Cl. A01B 15/00

(52) U.S. Cl. 172/684.5

(57) ABSTRACT

A box attachment for front end loaders, tractors and like vehicles to pull snow or other material from flat surfaces.

### CROSS REFERENCE TO RELATED INVENTION

This application claims the priority benefit of provisional U.S. Pat. application No. 60/227,268, corrected filing Jul. 26, 2001

### FEDERALLY SPONSORED RESEARCH

Not Applicable

### SEQUENCE LISTING OR PROGRAM

Not applicable

### BACKGROUND

1. Field of Invention

This invention relates to the movement of snow or other material in confined areas.

2. Description of Prior Art

Snow removal from commercial properties or residential driveways has been accomplished by various methods. Mechanical methods are preferred if there are large flat areas to be cleaned. The most common method is to push material by means of a plow, blade, or other device; but this would leave a lateral line as the material would flow to the edge of the blade. Pushing the material also requires the mechanical device to get behind the material to move it. The operator of the mechanical device has to get behind the material to be moved; they use their pusher devices to pull or drag material from walls, door, or other obstacles to get room to push the material. The pusher devices weren't designed to pull material, this use causes inefficiencies and reduced quality of the desired result. The use of a drag box makes the pulling of material from walls, doors, or other obstacles more efficient and produces a cleaner surface.

Historically, earth moving devices are used for snow removal. The result is that both large and small equipment designed for earth moving have been used as snow removal devices. The design of the drag box is to move snow or other material.

Hutchins, Et Al U.S. Pat. No. 4,869,326 discloses a box scraper with plural blade having movable moldboards so device can be pushed or pulled on a three point hitch.

Browning, U.S. Pat. No. 4,524,532 discloses a box blade with a movable closure blade that is used with a tractor with a three point hitch.

Hare U.S. Pat. No. 4,103,796 discloses an apparatus for attaching bucket or scoop onto a conventional three point hitch.

Lewis U.S. Pat. No. 3,319,367 discloses a scoop attachment for a tractor with a three point hitch where the holding bin is behind the scraper blade.

Lindquist, U.S. Pat. No. 2,565,384 discloses a scraper assy. Having a power actuated scraper portion for moving earth into a supporting bucket.

Bain, U.S. Pat. No. 2,558,531 discloses a scraper bucket having a retaining apron which can be moved to position closing the scraper to form a bowl.

The prior art shows devices to level earth, or to move earth over uneven ground to a different location. The Back Drag Snow Box is designed without any moving parts to move material such as snow over hard flat surfaces using a front end loader.

### SUMMARY

The back drag box was designed to move snow from confined areas to open areas.

### DRAWINGS

FIG. 1 shows a back drag box with a universal attachment plate (item 1), for use with front end loaders. Note this attachment plate can be modified to fit all types of front end loaders. No. 2 & 3 show replacement wear blades that can be made of materials other than steel. No. 4 is a sight flag to allow operator to judge how close the drag box is to the obstruction.

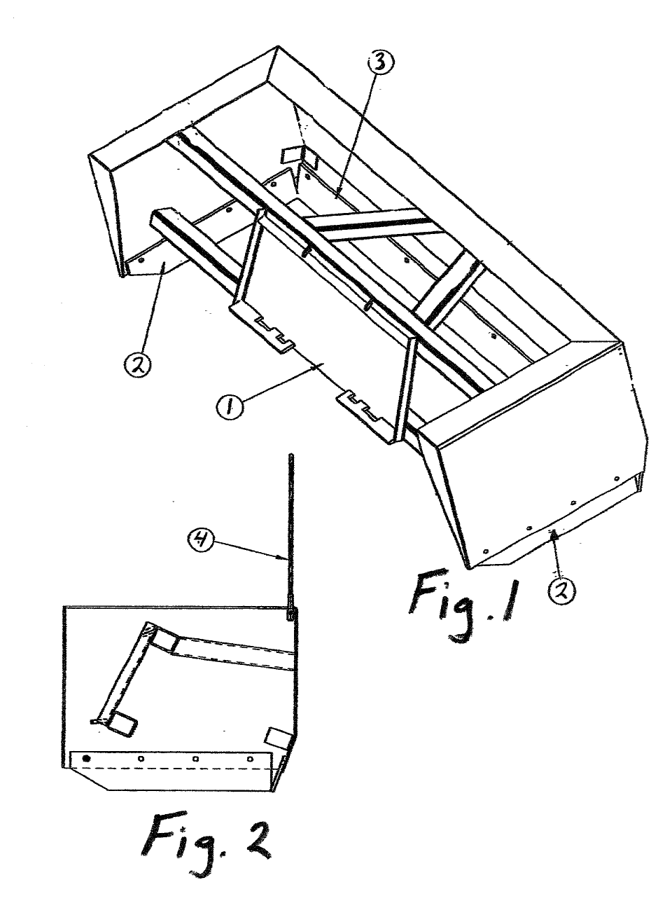

### ADVANTAGES

From the description above a number of advantages become evident:

(a) there are no lateral lines left by a plow blade

(b) most snow can be moved from an obstruction that can be moved by a plow

(c) the blades on the drag box can be replaced when worn

(d) depending on application, the blades can be replaced with other materials such as plastic, Teflon, rubber, or other materials

(e) the Back Drag Snow Box can be easily removed when a front end loader is required for other applications

(f) the Back Drag Snow Box will clean snow from the surface of a parking lot or driveway better than a plow or scoop that is dragged

(g) the Back Drag Snow Box does not have any moving parts

### OPERATION

The Back Drag Snow Box mounted on a front end loader is typically used in conjunction with a truck mounted snow plow. The snow box is used to drag snow from buildings, doors, or other obstructions to a place where the plow can then get behind the snow pile and move it to the desired location.

Another method of operation when a plow vehicle is not available, is to back drag the snow to a place where the front end loader can then move it with the snow scoop attachment.

### CONCLUSION

Accordingly the reader will see that the use of the Back Drag Snow Box will result in a cleaner driveway or parking lot, when compared with the back dragging of conventional push type plows or scoops. The Back Drag Snow box is more efficient than trying to back drag with push type plows or scoops. Then it follows that there is less wear and tear on the motorized vehicles used to clear snow when less passes are required.

What I claim as my invention is:

1. A scraping device with an open top, bottom, and back that attaches to a front end loader, and is used to pull material in a reverse direction.
